(19) United States
(12) Patent Application Publication
(10) Pub. No.: US 2009/0019060 A1
(43) Pub. Date: Jan. 15, 2009

(54) CREATING ONLINE SOCIAL LEARNING COMMUNITIES

(75) Inventors: Jason BECKERMAN, East Brunswick, NJ (US); Joshua Backer, Atlanta, GA (US)

Correspondence Address: BUCHANAN, INGERSOLL & ROONEY PC, POST OFFICE BOX 1404, ALEXANDRIA, VA, 22313-1404, US

(73) Assignee: EDUCATIONAL COMMUNICATIONS LLC, Ocean Ridge, FL (US)

(21) Appl. No.: 12/168,607

(22) Filed: Jul. 7, 2008

Related U.S. Application Data
(60) Provisional application No. 60/929,659, filed on Jul. 6, 2007.

(51) Int. Cl. G06F 3/00; G06F 17/30

(52) U.S. Cl. 707/10; 715/753; 707/E17.032

(57) ABSTRACT

Distributing knowledge through a learning community includes creating a plurality of learning communities; for each of the plurality of learning communities, allowing creating a knowledge base by the content producers, allowing submitting content to the learning community by the content consumers or the content producers; sharing contents with the content consumers and content producers in many ways. The learning communities are listed in a directory. A category in the directory is able to be drilled into for multiple levels. Each of the multiple levels of the categories in the directory is associated with one or more of the plurality of learning communities.

This application claims the benefit of Provisional Application No. 60/929,659, filed on Jul. 6, 2007.

### FIELD OF DISCLOSURE

The present disclosure relates to a method and system for creating and implementing online social learning communities. The social learning communities allow content producers to create knowledge base to be shared with content consumers in multiple ways.

### BACKGROUND

The Internet is a widely used global computer network. The computers of the Internet are linked via globally unique address called Internet Protocol (IP) addresses. As the Internet gains popularity, online courses, which allows students to take the course at a location of choice, become increasingly common.

However, online courses have many limitations. For example, an online course has an expiration date.

What needed, therefore, are a more flexible and effective way for sharing and distributing knowledge.

### SUMMARY

A method and a system for distributing knowledge through a learning community are described herein.

In accordance with an aspect of the present disclosure, a method for distributing knowledge through a learning community includes creating a plurality of learning communities; for each of the plurality of learning communities, allowing creating a knowledge base by the content producers, allowing submitting content to the learning community by the content consumers or the content producers; sharing contents with the content consumers and content producers in many ways. The learning communities are listed in a directory. A category in the directory is able to be drilled into for multiple levels. Each of the multiple levels of the categories in the directory is associated with one or more of the plurality of learning communities. A system for distributing knowledge through a learning community, comprising:

In accordance with another aspect of the present disclosure, a system for distributing knowledge through a learning community includes means for creating a plurality of learning communities means for allowing creating a knowledge base by one or more content producers; means for allowing submitting content to the learning community by at least one of the one or more content consumers and content producers; and means for sharing contents with the one or more content consumers and content producers in a plurality of ways. The plurality of learning communities are listed in a directory; a category in the directory being able to be drilled into for multiple levels; each of the multiple levels of categories in the directory associated with one or more of the plurality of learning communities.

### BRIEF DESCRIPTION OF THE DRAWINGS

FIG. 1 illustrates a related art computer network;

FIG. 2 illustrates an example of a community list;

FIG. 3 illustrates a community content structure;

FIG. 4 illustrates an example of a review system;

FIG. 5 illustrates an example of community profile information;

FIG. 6 illustrates an example of a point system;

FIG. 7 illustrates an example of an approval process;

FIGS. 8A and 8B illustrate management team functions;

FIGS. 9A, 9B and 9C are a functional block diagram of learning community creation functions;

FIG. 10 is a functional block diagram of attendance and levels functions;

FIG. 11 illustrates an example of content item levels and subscribers' levels;

FIG. 12 illustrates an example of an open question functions;

FIG. 13 illustrates an example of a wants and wishes system;

FIG. 14 illustrates another example of the wants and wishes system;

FIG. 15 illustrates an example of attendance level;

FIG. 16 illustrates an exemplary system network configuration for implementing the online learning communities;

FIG. 17 illustrates an example of a virtual economy system;

FIG. 18 illustrates an example of a learning flow system; and

FIG. 19 illustrates an example of a community certification system.

### DETAILED DESCRIPTION

### Overview

This disclosure allows users to create online learning communities around any topics, for example, from video games to carpentry, and from dog training to philosophy, by community creation processes.

### Computer Network in General

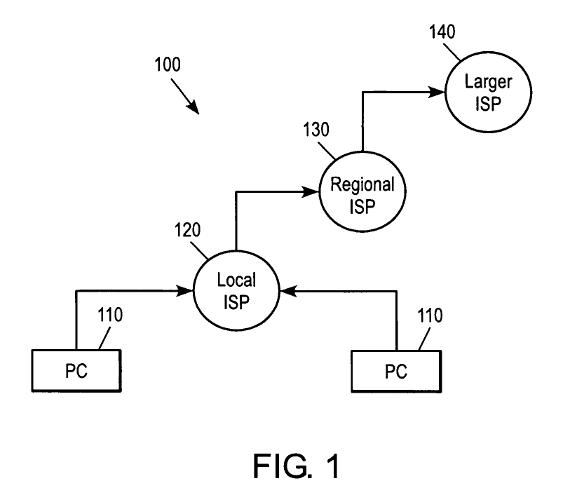

FIG. 1 illustrates a computer network 100 (e.g. the Internet), which includes a plurality of computers linked to one another. For example, a personal computer (PC) 110 may be linked to the network 100 via a phone-line modem, DSL, fiber optics or cable modem or wireless that communicates to a local internet service provider (ISP) 120.

Local ISPs 120 are then connected to regional ISPs 130 which are then connected to even larger ISPs 140. In this way, every computer on the Internet is connected to every other computer on the Internet, although the invention can be implemented on other networks. Each computer on the Internet is identified by a unique IP address.

The exemplary embodiments of the present invention are facilitated by computer networks, such as the Internet.

### Exemplary Community Creation Process

A Community Creation process takes the community owner through the process of setting up a new community.

When the community owner clicks creating a community, they are taken through a Community Creation process, as illustrated FIGS. 9A, 9B and 9C.

As shown in FIGS. 9A, 9B and 9C, in block 910, the owner sets properties of the community to be created, for example, the name of the community, the statement of purpose for the community, the community goals, and the owner's perspective on the community topic. The owner also sets who the primary target market is for the community.

In block 920, the owner then sets tags for the community which are keywords to describe the community being established.

In block 921, a user sets a “wants and wishes” item, if applicable, which is described in more detail below.

In block 930, the owner can set lectures that are to take place. If applicable, the owner chooses the types of the lectures, as shown in diamonds 931 and 935. These lectures can either be live downloaded or streaming video files, as shown in blocks 933 and 934. If the lecture is live, the owner can set a date and a time, as shown in block 934, for the lecture, and any subscriber, e.g., content consumer, or user, who is joined to the community can see the event on their calendar. The owner can bring in third party lectures from within the parent system (service) by sending an invitation, as shown in block 932. The owners of these lectures can receive an invite, and if accepted, their lectures are added to the community. These lecturers can become part of the community management team.

In blocks 930, 940, and 950, the owner can add images, videos, and audio files to the community.

In block 960, the owner can attach documents and reading materials which can link to a third party store for purchase, as shown in block 961.

In block 970, the owner can set the topics and sections for the communities' discussion board.

In block 980, the owner can set paper topics and criteria for successful paper submission.

In blocks 990 and 995, the own can set level of the community based on community attendance system, which is described in more detail below.

In diamond 992, the owner decides whether the community should have levels. If the decision is no, all levels are set to zero, as shown in block 993. If the decision is yes, the owner sets custom names for the different levels, and sets attendance goals for each level, as shown in block 994.

In block 991, the owner can set level for the content items in the community. In diamond 996, the owner decides whether the content should have level restriction. If the decision is no, all levels are set to zero, as shown in block 997. If the decision is yes, each item submitted in the community creation section is given a corresponding level which restricts visibility to users with that level or above, as shown in block 998.

The community creation process allows the owner to set access controls, which is described in more detail below. As shown in block 9100, the owner can set up a community management team. In diamond 9111, the owner decides whether the community has a management team. If the decision is no, the owner is set to all roles, as shown in block 9113. If the decision is yes, the owner chooses management team members from a source, e.g., a list of friends, and set roles for each of the member, as shown in block 9112.

In blocks 9200 and 9211, the owner can save the community setting for later editing and displaying.

When the community setting is ready to be deployed, subscribers can be invited from various sources, as shown in block 9300.

Once the community creation process is finished, the community home page is displayed, as shown in block 9301.

### Exemplary Community Listings

A community listing 200 provide a directory of all of the communities that are currently in the parent service system.

A category in the directory is able to be drilled into for multiple levels. Each of the multiple levels of the categories in the directory is associated with one or more of the plurality of learning communities.

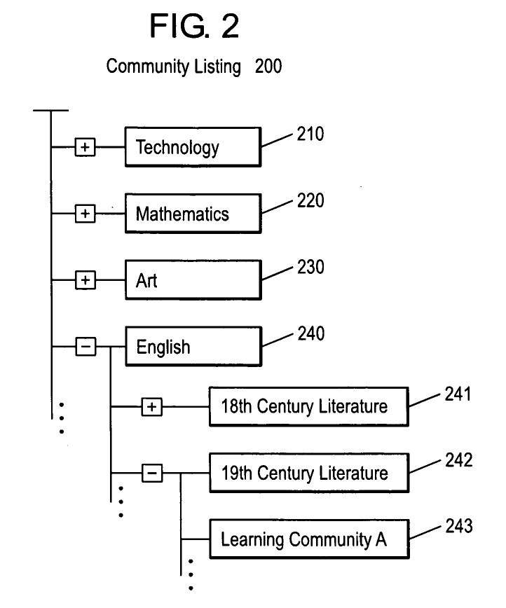

As shown in FIG. 2, the end user is able to search on subject, such as Technology 210, Mathematics 220, Art 230, and English 240. Furthermore, the user is able to drill down through sub topics. For example, the category of English can be drilled down to include sub topics, such as, 18th Century Literature 241 and 19th Century Literature 242. The sub topic 19th Century Literature 242 includes various learning community, such as Learning Community A 243.

Next to each community name is the community owner's name, the rating, number of reviews, current amount of students broken down by level, and the total amount of content, for example, one Gigabyte, included within the level. The cost, if there is any, is listed.

This list view is sortable by each of these columns. When a community name is drilled down on, it brings the user to a community profile. If the reviews link is drilled down on, it brings the user to the list of reviews (detailed below) for the community. If the community owner's name is drilled down on, it brings the user to a list of other communities being given by the community owner. Above the list of communities is the additional sub categories for the chosen category. This entire section is searchable. If the currently logged in user is already enrolled in the community, the name of the community is bolded.

### Exemplary Profiles Information

Profile information may be provided for user to obtain a quick view of the learning community, or the user.

The community profile is accessed from the community listings page by drilling into a community name. On the community profile page, the following may be included: a summary of the community, reading materials for the community, random subscribers available for reference, community reviews, and number of spaces available.

This summary includes a short description of the community and can show the variables pertaining to the community levels.

The community profile may show the various levels and attendance required in order to make it to each access level, which is described in detail below.

In addition, the reading materials for the community can be shown. There is a section which includes a random sampling of subscribers from each level in the community. These subscribers can be contacted to ask questions about the community.

The reviews for the community and the community owner can also be shown. The subscriber sees the space available in the community, and the price of the community, if applicable.

The subscriber may be the community on a watch list for easy access on a subsequent login. There may be a “refer a friend” button which allows a user the ability to send the community information to a friend. This friend can be either internal to the parent service or external. The potential subscriber is able to enroll in the learning community through an enrollment screen.

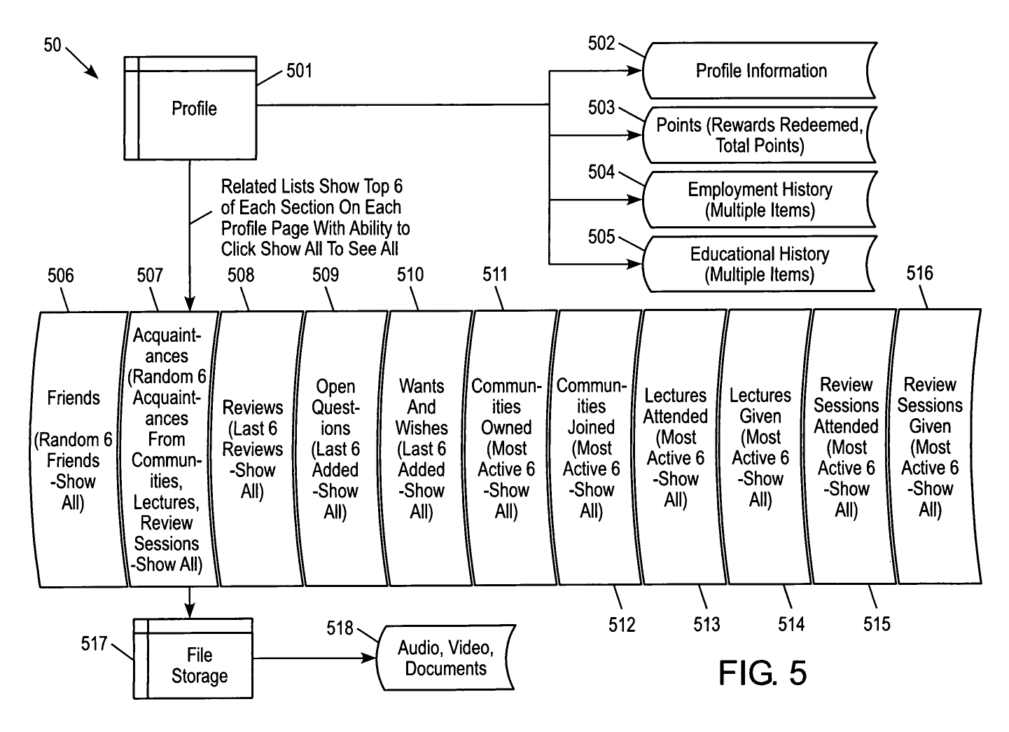

FIG. 5 illustrates an example of user profile 50. Referring to FIG. 5, the user profile include basic profile information 502, points information 503, employment history 504, and educational history 505.

The profile may also include related lists to show top items from selected categories of items, such as open questions and friends, as shown in blocks 506-516.

FIG. 5 also illustrates that the information on file storage may be provided to list the audio video documents 518 in the file storage 517.

### Community Owner and Management Team

A community management team is designated after the community is created. The community owner and management team are responsible for the overall success of the system.

While the owner has full access to all of the abilities within the community, each management team member can have their own role or roles which would then drive their community abilities. These roles can be set from the parent service system, and it then gives community owners the ability to choose system users to add to their community, and then set a specific role or roles for the system user.

When a management team member enters the community, their view would be different than the end user. The management team member would have approval queues and the ability to add content based on their role or roles. The management function is described in more detail below.

### Community Content Structure

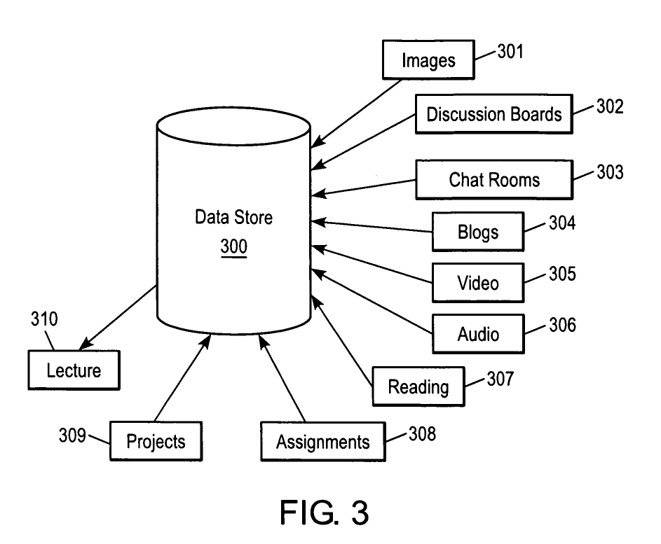

In general, the community content management structure comprises a data store which holds various types of contents, e.g., images 301, discussion boards 302, chat rooms 303, blogs 304, live and static video 305, audio files 306, reading materials 307, assignments 308, projects 309 and lectures 310, as shown in FIG. 3.

In addition, the community content system can have a user structure of community owner, community management team, and community subscribers/users.

### Commnunity Video Chat Room

The community video chat system can be used for live lectures as a part of the communities. The video chat system can have a chat room where subscribers can chat among themselves in a standard chat format. Subscribers can also have the option of sending questions to the community owner or management team member conducting the lecture. These questions can be made viewable by all subscribers in the chat session. Each subscriber is able to rate the questions on the pending questions list. The questions are sorted by an average of the scores obtained from the group of subscribers and the lecturer then addresses the questions in this order. This will allow for the top questions to be answered if there is a limited amount of time. If a question on a video lecture is not answered, the unanswered questions can be added automatically to the Open Questions function so the questions can be answered at a later time. All logs and video feeds from the community Video Chat Room will be saved and accessible at a later date.

### Community Discussion Board

A community discussion board can be used for communities. While a discussion board is most typically standard web technology which allows users of the board the ability to post a message and then post a response. The community discussion board can have additional features such as a drop down box with Questions, Responses, Comments, or a custom set information by the community owner. This can aid in the organization and searching of discussion board postings. The discussion board can also calculate how many new postings there is that have not been viewed by a specific subscriber. The discussion board can accept HTML and there can be a built in spell check utility. The discussion board can also count the number of words used and show this in comparison to the word limit set by the community owner for a specific post. Lastly, the discussion board can automatically search postings for double quotations to calculate how many quotes were used in a given posting.

### Community Attendance System

The community attendance system tracks the attendance of community subscribers to allow for an automated content access system.

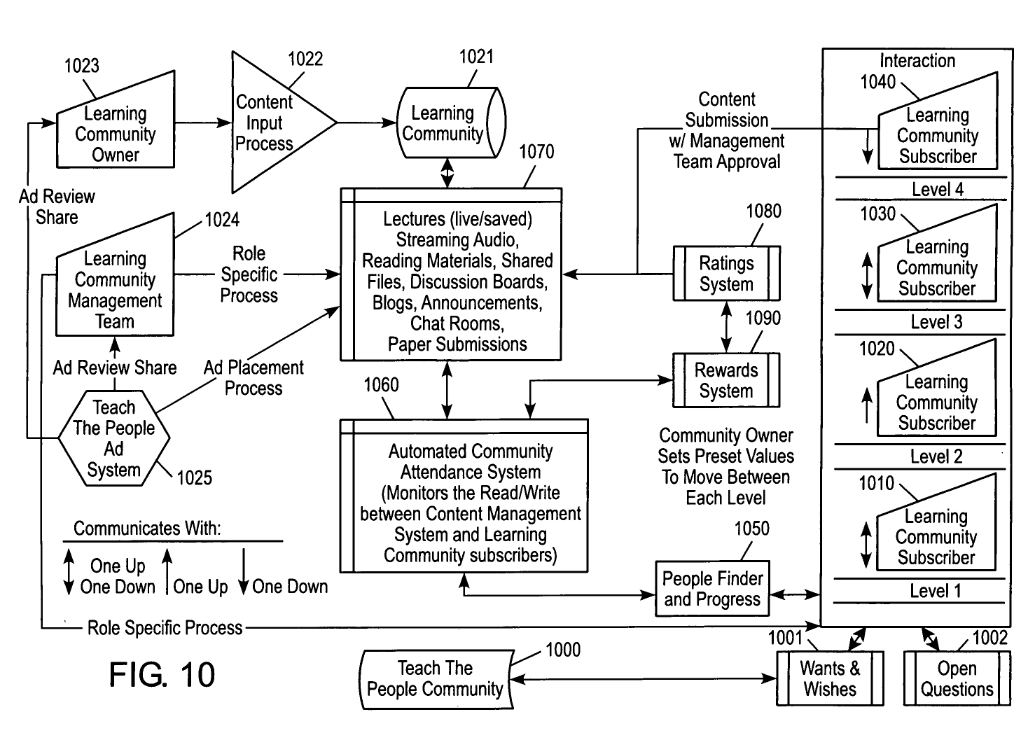

FIG. 10 illustrates a functional block diagram of attendance and levels functions. When a subscriber signs up for a community, the subscriber may posts wants and wishes 1001, and open questions 1020. Thereafter, the subscriber's activities are tracked. The subscriber's activities include, for example, each discussion board posting per subscriber broken down by type (for example, count, average time delay in posts, average word count), papers submitted per subscriber (for example, using word count boolean, quote count), chat sessions participated per subscriber (for example, count), downloaded learning community materials, watched and listened to multimedia content, watched lectures, questions asked during lectures, contact with lower level community members for mentor process, answering open questions, custom manual attendance criteria, reviewing content, reviewing subscribers, and reviewing community owners/management.

The system logs the appropriate information in order to obtain these metrics and produce them in the format of a report.

The community owner, management, and other subscribers can determine which subscribers are producing the most community content and who is producing the least based on the attendance system.

Subscriber are given different statuses, which correspond to different abilities within the plurality of learning communities, which includes different levels of access.

The community attendance system can also automatically color code the subscribers name in various places within the platform to illustrate to a content producer how the subscriber is proceeding through the community. The color coding can be viewable by the other subscribers in the community so they can see which subscribers are active participants in the learning community.

This platform can be used to determine when users can move from a beginner status to an expert status and the access levels in between. The levels are set during the community creation process, but they are tracked through the attendance system. For example, learning community subscribers can move among level 1 1010, level 2 1020, level 3 1030, level 4 1040 based on the tracking results of the attendance system, as shown in FIG. 10.

The ratings system 1080, which provides rating of content submitted by the subscribers, and the rewards system 1090 can also affect the tracking results of the attendance system.

When a new learning community is created, the community owner sets these levels during the creation process. All content is on the site immediately but added to an approval queue. All submitted content from subscribers is preferably approved by either the community owner, or the community management team 1024. Once the item is approved, the subscriber receives attendance credit and reward points. This is designed to reduce the incidence of people from submitting bogus content and span.

The community management team 1024 and owner 1023 may be responsible for submitting additional content through a content input process 1022 to data store 1070 of the learning community 1021, approving/reviewing content submitted by subscribers, and removing content, as illustrated in FIG. 10. In addition, an advertisement may be placed in the system through an advertisement placement process.

### Community Approval Process and Management Team Function

The community approval process is invoked when a user submits any type of content to the community.

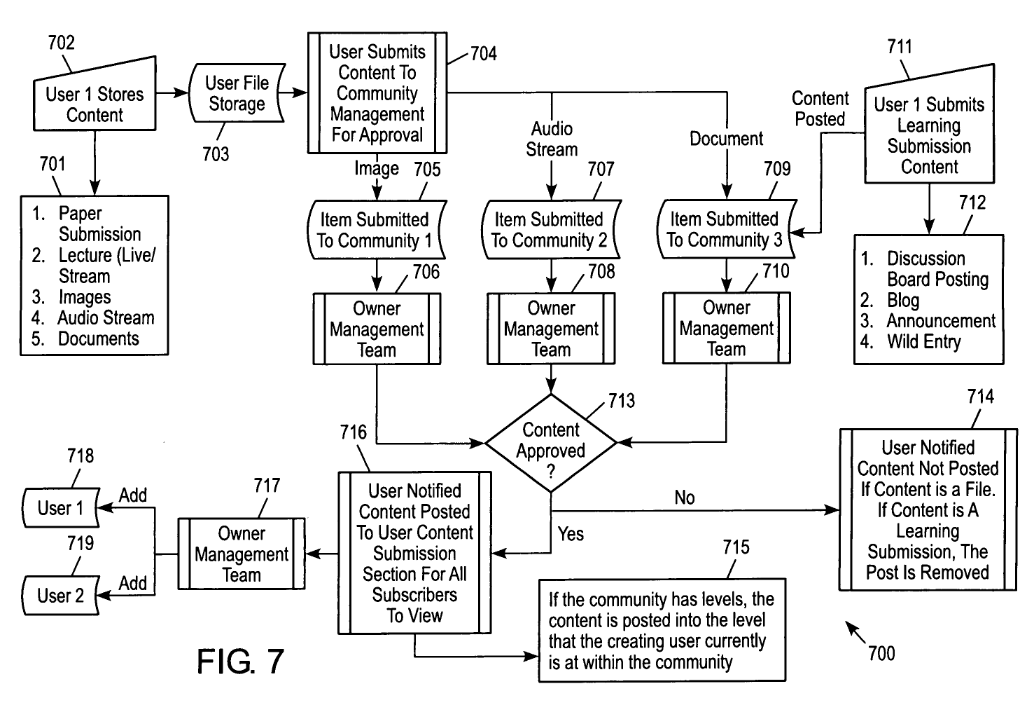

FIG. 7 illustrates an example of the approval process. A user 702 may store various material 701 in a user file storage 703. In block 704, the user submits contents 705, 707 and 709 to the respective community management teams 706, 708 and 710 of communities 1, 2 and 3, for approval. The contents may be submitted to various communities.

In block 711, a user may submit learning submission content to the community. The learning submission content is posted to the community.

In diamond 713, the community management teams 706, 708 and 710 determine whether the respective materials submitted are approved. If yes, in block 716, the user 702 is notified of the post of the submitted material. In block 715, the content is posted into a level that the user 702 is at within the community. If the content is not approved, in block 714, the user 702 is notified that the content submitted is not posted. If the content is a learning submission, the post of the learning submission content is removed. The owner/management team 717 can act like a gatekeeper for the content for the users 718.

The community approval process is associated with community management functions, which include, for example, reviewing content submitted; approving or denying content submitted, and adding or removing contents for the plurality of learning communities.

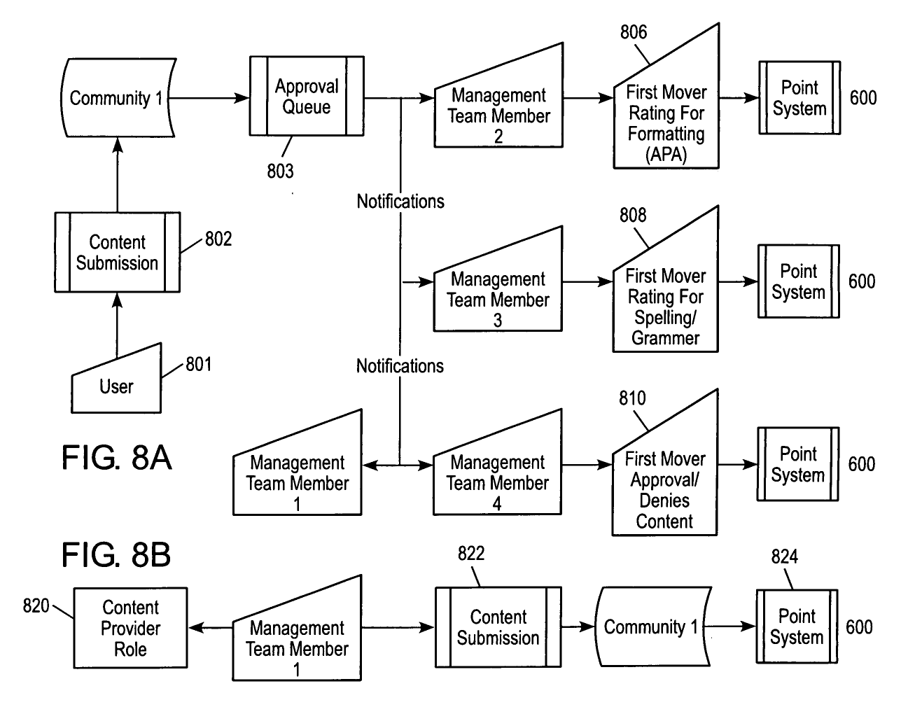

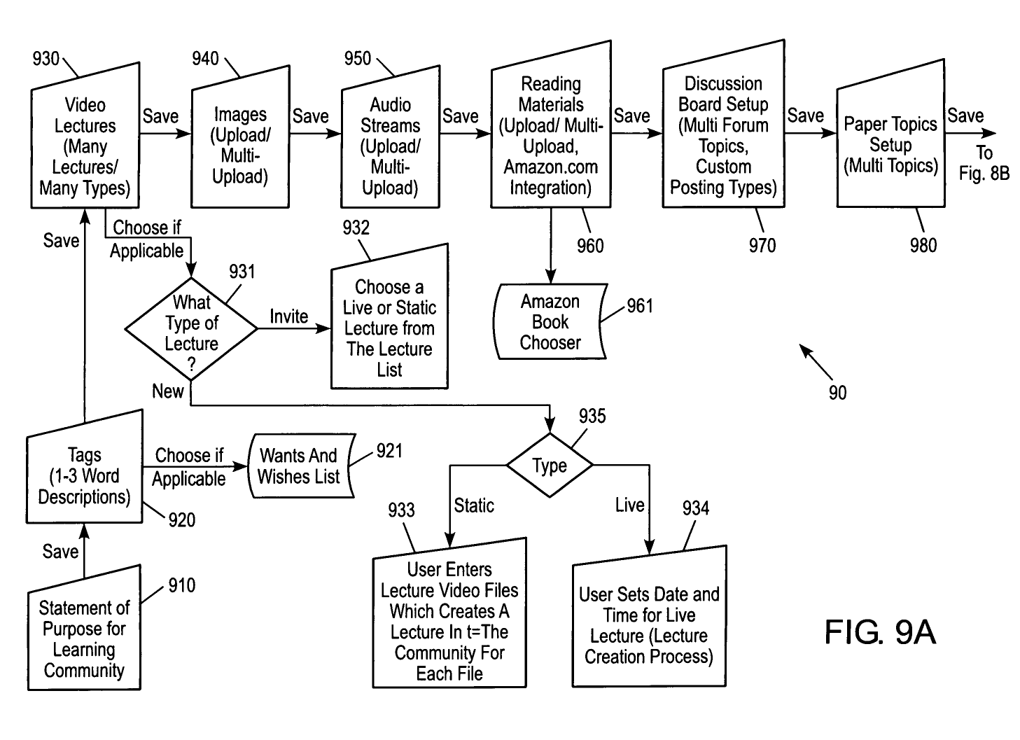

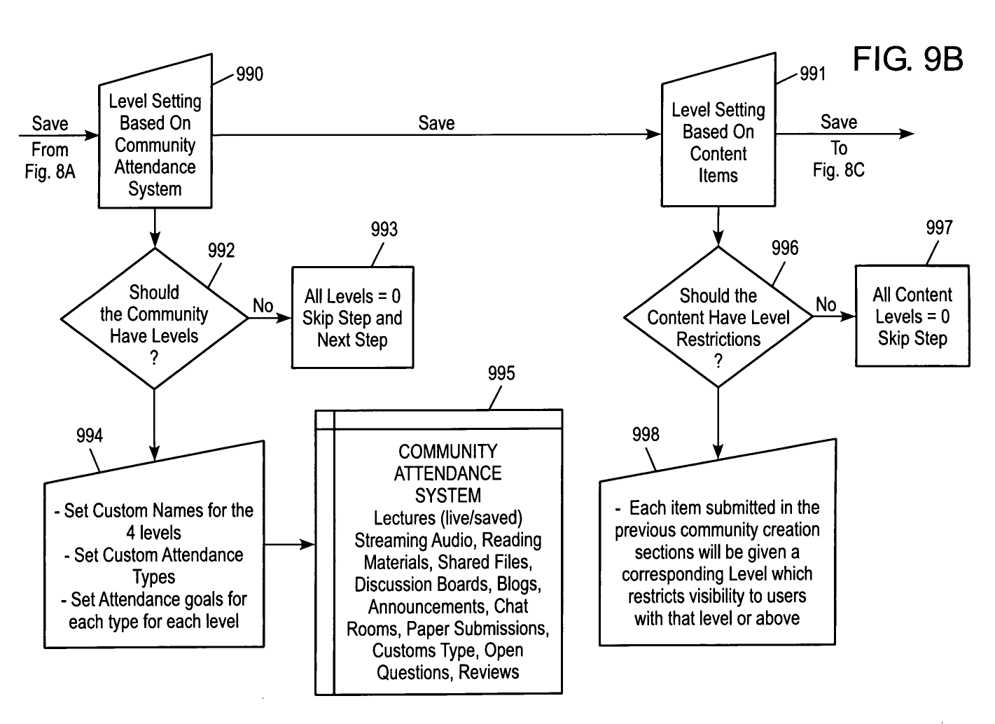

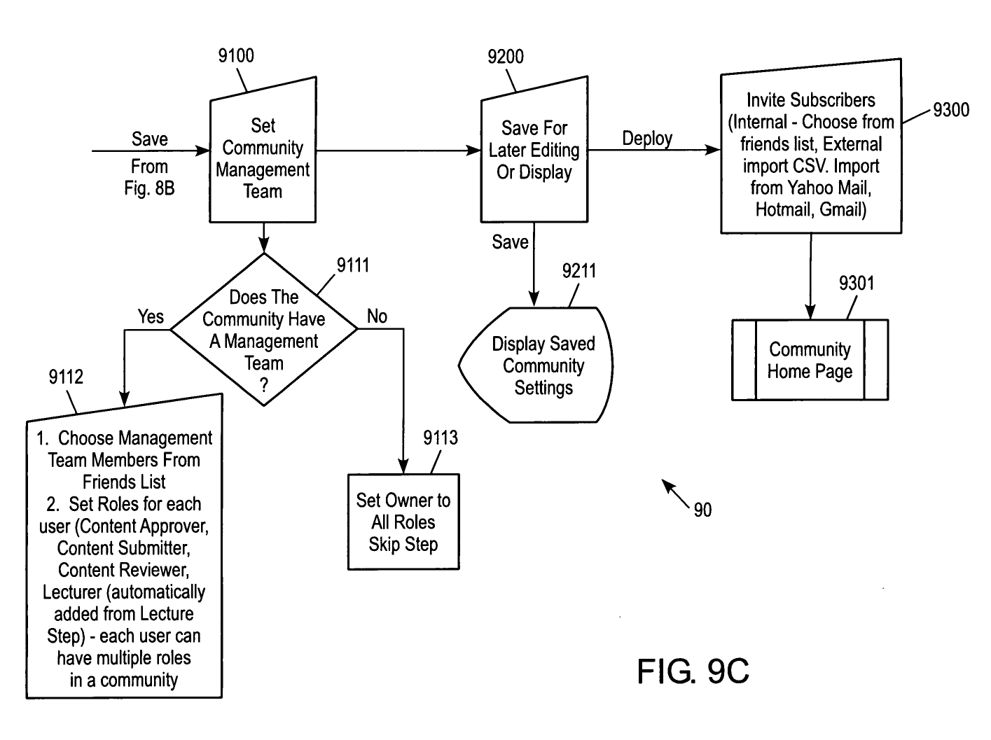

FIGS. 8A and 8B illustrate an example of management team functions. The content submitted by a user 801 through content submission 802 to community 1 is automatically sent into the community, but is flagged as pending approval. A record is added to the community management approval queue 803, and when a member of the community management team enters the community 1, they see a list of items waiting approval.

Management team member 2 reviews formatting of the content in block 806, and points are rewarded based on the content. Management team member 3 reviews spelling or grammar of the content in block 808, and points are rewarded accordingly. Management team member 4 and management team member 1 approve or deny the content in block 810, and points are rewarded accordingly.

If the item is approved, the flag is removed from the item, and both the management team member and submitter get reward points for their role in producing the content.

If the item is rejected, it is removed from the community, sent back to the submitters' drafts box, and a message is added to it describing the reason for the rejection.

In FIG. 8B, once the content submitted by a user in the content provider role 820 to the management team member 1 is approved, the content is posted in community 1, and points are rewarded accordingly.

### Review System

The subscribers receive community points for every action they take within the community in the attendance system. Subscribers and owners/Managers subscribe to own, and manage multiple communities at one time. While a person might own one community, they might manage another, and subscriber to another, all at the same time.

To drive content creation and quality monitoring of content, subscribers can be rewarded with points, while owners and managers can be rewarded with shared ad revenue and/or points. Points can be redeemable for rewards such as additional storage for the hosting of files and the building of communities.

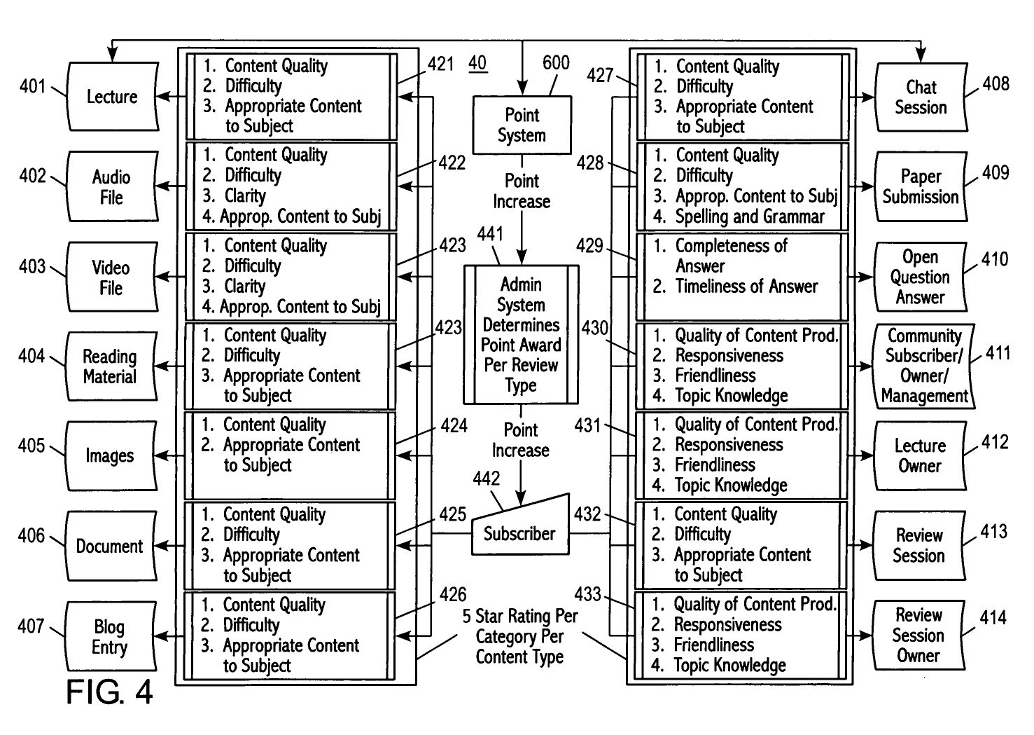

As shown in FIG. 4, the different types of contents submitted 401-414 by subscriber 442 are reviewed through their respective review processes 421-433 in the review system 40. Upon approval of the content, points are rewarded to the subscriber 442 who submitted the contents 401-414.

### Community Point System

Activities of the users in various roles, such as content owner, and content consumers, may be tracked in a community point system 600. The community point system 600 drives continued use of the various communities within the parent service.

There are many different ways a person can receive points. For example, every action subscribers take to participate in the community could have an associated point reward. Points drive the amount binary content, which includes images, pictures, documents, video and audio made available to the subscriber.

Community management teams and community owners receive points for participating in running or managing an online community.

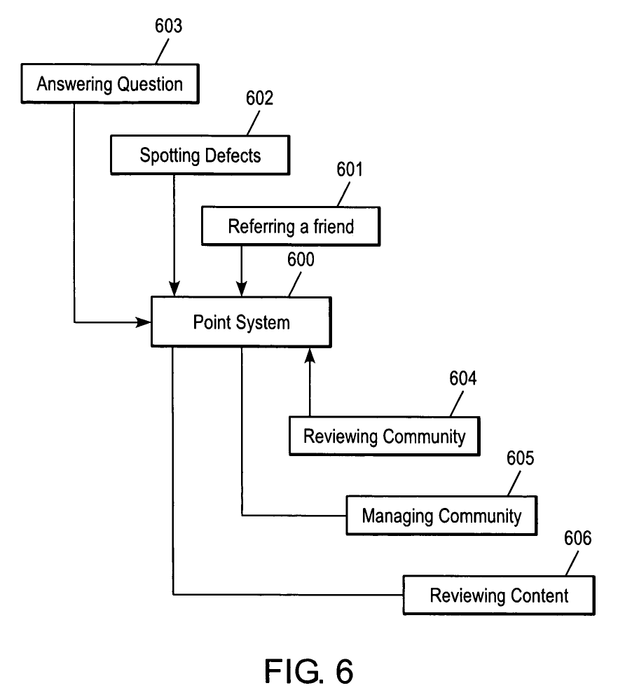

In FIG. 6, examples of the participating activities are illustrated. Answering open questions 603, which is detailed in a subsequent section, awards points. spotting community related defects 602, referring a friend 603. Reviewing communities 604, community management, and other subscribers 605 also award points. Lastly, reviewing community content submitted by community owners, managers, or subscribers 606 also reward points.

These points are used within the parent service to rank most active members. The points are redeemable for such things as prizes, free access to fee based communities, storage space and other suitable rewards, determined by the administration system.

Since users are capped on storage space at a set amount in the administration panel, as users accumulate points, they are able to turn those points into additional storage for content includes images, pictures, documents, video and audio. Subscribers, or users, can turn the points into storage space, and then the user's storage cap is increased. In addition, users can sell or even purchase points in order to obtain additional storage space. Storage is typically used for the creation of learning communities. Every user starts out with a set amount of points that can then be turned into learning communities. Point values for above are set in the administrative panel in certain embodiments.

### Access Levels for the Communities, Content Items, and Subscribers

A community can be made public or private. The community can also have settings such as but not limited to invite only, Request to Join, Password Protected, and Max Subscribers.

A learning community is assigned one or more access levels when created. Each of the contents in the learning community is associated with an access level. A content consumer joins the learning community at the lowest access level, and moves up the access levels according to points accumulated in the point system 600, as described above. Points and the content consumer can only access a content in the learning community associated with an access levels not greater than access level of the content consumer.

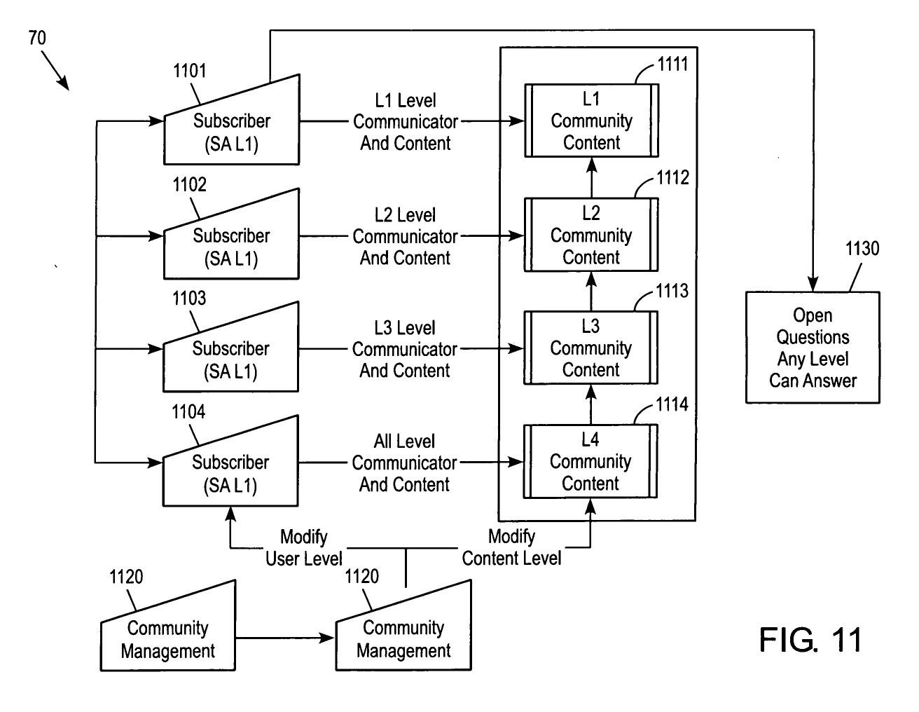

FIG. 11 illustrates an example of content items levels and subscribers' levels. A first subscriber 1101 assigned level 1 and can access level 1 content items 1111. Likewise, a second subscriber 1102, a third subscriber 1103 and a fourth subscriber 1104 can access level 2 content items 1112, level 3 content items 1113, and level 4 content items 1114, respectively. The community management 1120 can modify the user level, or the content level.

In addition, a user can access content items with levels that are level than the user's level. For example, a user with level 3 can access the content items with levels 1, 2, or 3.

As shown in FIG. 11, the management team 1120 can modify the user level, or content level.

In addition, an open question can be answered by a subscriber with any level, as shown in block 1130.

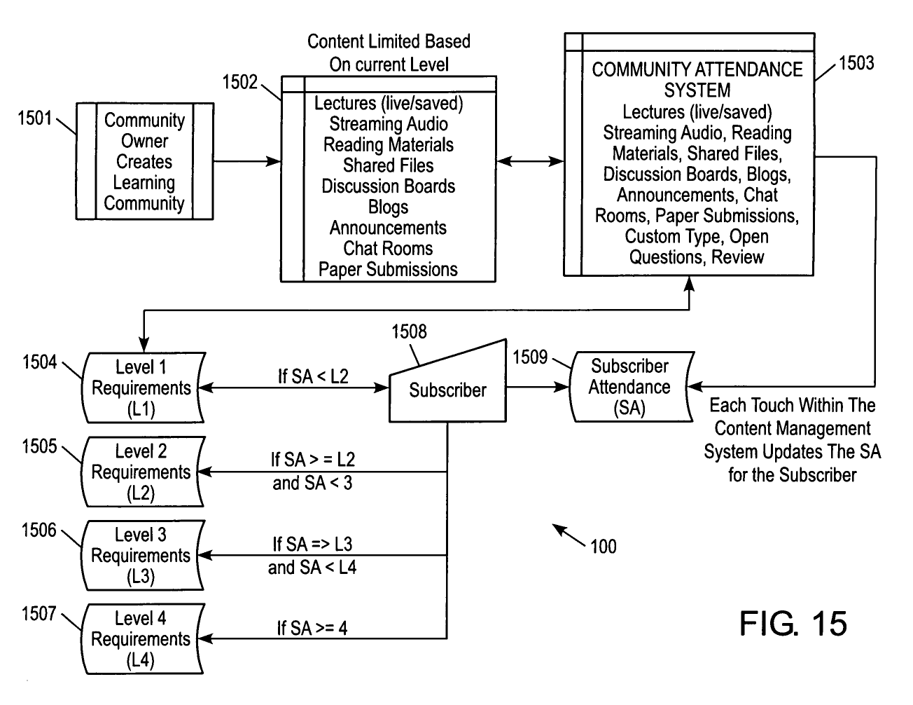

FIG. 15 illustrates an example of attendance level. In block 1501, a community is created. The content viewable to the user is limited to content levels of the current level, as shown in block 1502. Each interaction between the content and the subscriber 1508 is tracked by the community attendance system, as shown in blocks 1503 and 1509. The subscriber's level is determined based on the subscriber's attendance, as shown in blocks 1504-1507.

### Calendaring and Task Functionality for Community Owners and Subscribers

The calendaring and task functionality are seen on the home page of the parent service. This functionality works directly in function with the community creation system as detailed above. When a subscriber signs up for a community, any content items with a date (e.g., chats, live lectures, assignments, etc.) is automatically added to the subscriber's calendar. The calendar has notifications through screen pops as well as text messages. This allows a greater ease of knowledge acquirement and community administration for subscribers. The calendar also holds review dates for community owners. Once an item is submitted, the community owner has a predetermined amount of time to provide a review of it. As subscribers enroll in multiple learning communities, a weekly agenda is automatically emailed to show what is on the agenda for each community that week.

### Open Questions System

When a subscriber has a question that they are unclear about, they can post it on their Open Questions wall within their profile or on the open questions wall within the community, and solicit response from any subscriber, or for subscribers that have attained a specific level in the community.

All open questions for all learning communities are seen at their profile level. This question are then seen on the Open Questions section of any subscriber who has taken or attended the specific community in the past, and who received an average friendliness rating above a predetermined level.

In addition, the owner who is running the community receives the question as well. The previous subscriber or community owner can answer the current subscriber's question. If the answer satisfies the current subscriber, they can choose a button which says “Question Answered” or the like. Otherwise, the previous and current subscriber can chat back and forth through the messaging system until an answer is obtained.

This question and answer session can be saved into the community directory, so if anyone has a similar question in the future, it can be recommended or searched. The answering subscriber receives community reward points for answering the question.

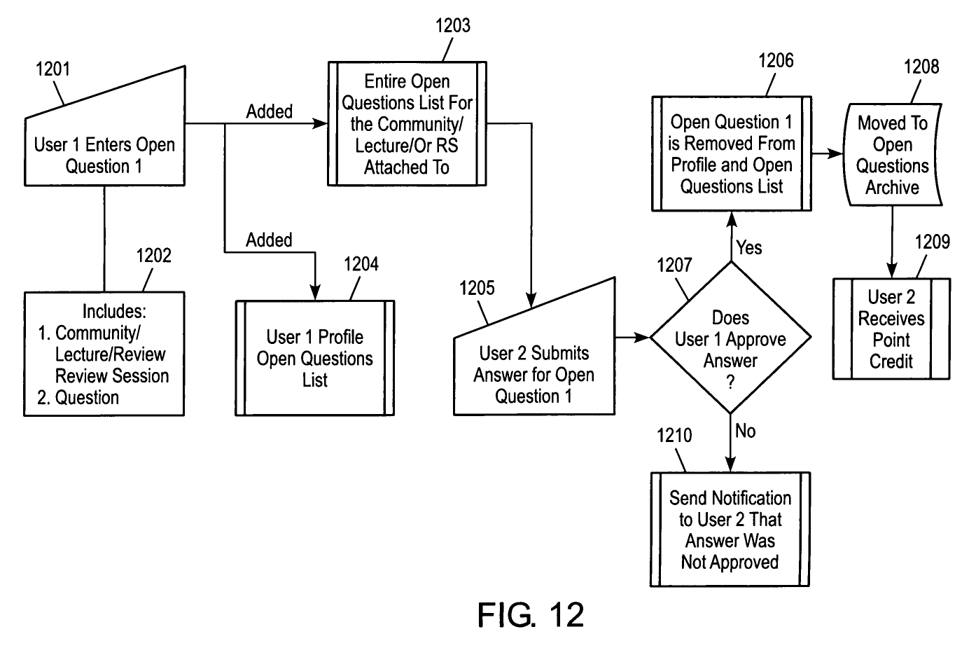

FIG. 12 illustrates an example of an open question functions. In block 1201, a user can post open questions 1202 to a question list for the community 1203, or a user profile open question list 1204. In block 1205, another user can submit answer to the questions on any question lists. In block 1207, such answer is reviewed by the user who posted the question. If the answer is approved, the open question is removed from the open question list, as shown in block 1206, and moved to an open question archive, as shown in block 1208. In block 1209, the user who answered the question receives points in the point system 600. If the answer is not approved, the user who answered the question receives notification that the answer is not approved, as shown in block 1210.

### Wants and Wishes System

The wants and wishes system of the site allows subscribers to post what type of communities they would like to see on the parent service system. The wants and wishes system searches to see if there are any similarities in the subscriber's request to first, other communities already created, and second, existing wants and wishes. The wants and wishes system attempts to match the new wants and wishes entry with an existing one. This aids in data quality. This information is sent to the parent service system administrators on a periodic e.g., weekly basis for a weekly or monthly newsletter to community owners.

This tool allows the parent service to estimate which new communities would be in the highest demand. When a new community is created, the community can be tagged with a wants and wishes entry if the community satisfies the description of the entry, and subscribers who have submitted a wants and wishes request can automatically be notified that the learning community was created. A user can also see a list of Wants and Wishes on another user's profile. There is an “add” button, which allows that user to add the Wants and Wishes entry to their profile as well.

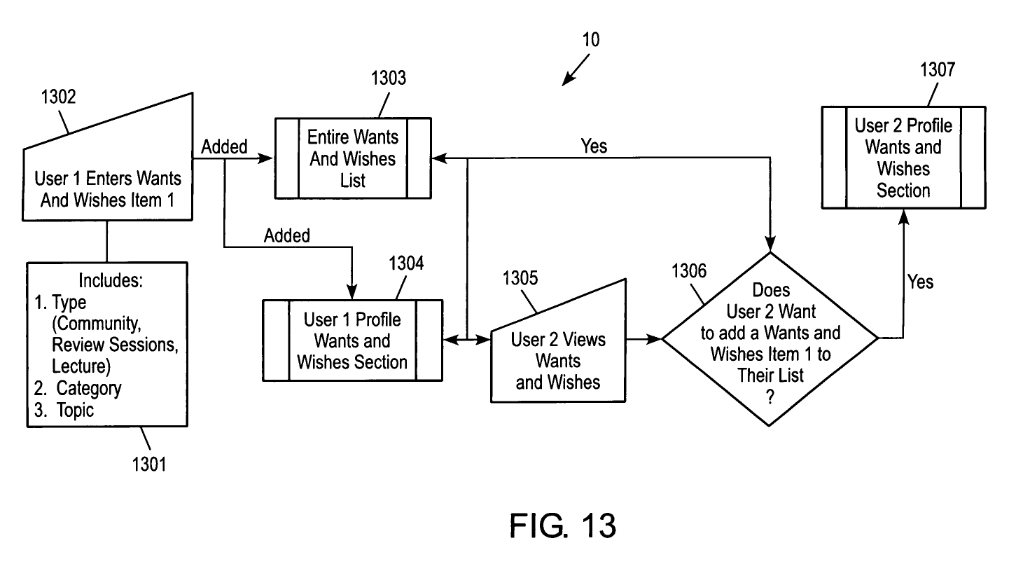

FIG. 13 illustrates an example of the wants and wishes system. In block 1302, a user enters wants and wishes items, including, for example, the type, category or topic of wants and wishes items, as illustrated in 1301, in a wants and wishes list 1303. The wants and wishes items can also be added to the user's profile sections. In block 1305, a second user can view the wants and wishes lists. The second user can decide to add a wants and wishes item to his own user's profile wants and wishes list, as illustrated in 1306 and 1307.

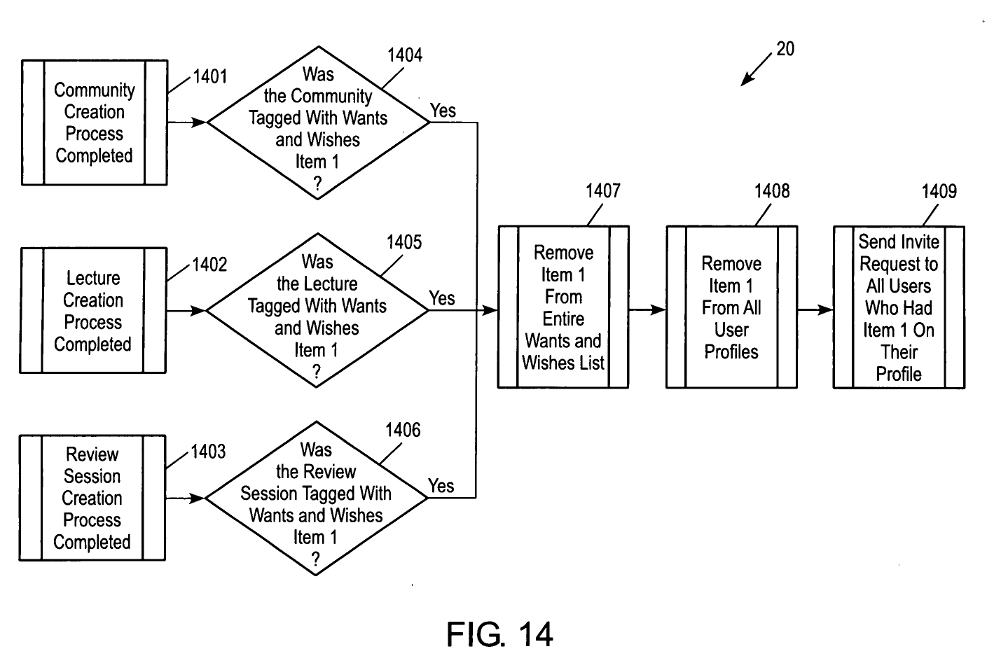

FIG. 14 illustrates another example of the wants and wishes system. In FIG. 14, once the community creation process is completed 1401, it is determined whether the community is tagged with a wants and wishes item 1404. If yes, the item is removed from the entire wants and wishes list 1407, from all user's profile 1408. In block 1409, all users who had the item on their wants and wishes list are notified of the community created. Similar process can be done for lecture creation process and review session creation process, as illustrated in blocks 1402, 1403, 1407, 1408 and 1409, and diamonds 1405 and 1406.

### Virtual Economy System

The subscribers, owners and content producers may be paid or charged in the online learning community. For example, advertisement revenue may be paid to owners or content producers. The subscribers may be charged a tuition to join a learning community.

Instead of paying and charging the subscribers, owners and content producers through a transaction that involves external accounts, such as checking accounts from batiks, a virtual economy system is established to allow easier transactions involving monetary values.

Each of the subscribers, owners and content producers can be a virtual economy account owner. The money earned in the online learning community, such as, advertisement revenue, can be credited in the virtual economy account of the owner or content producer who runs the advertisement. The money to be charged to a user, such as tuition for certain community, can be debited from the virtual economy account. In addition, the virtual economy system allows the account owners to borrow a loan by allowing values of their respective virtual accounts to be negative.

The economy virtual accounts can be funded through a third-party payment service, such as credit card companies, and other services, including GOOGLE, AMAZON, or PAYPAL payment services.

The balance of the virtual economy account can be debited to a bank account, at the account owner's choice.

The virtual economy system can pay an interest on balances maintained in the virtual accounts. In addition, the virtual economy system can track tax identifications of virtual account owner; and associate the tax identifications with transactions of the transferring a monetary value from or into the virtual accounts.

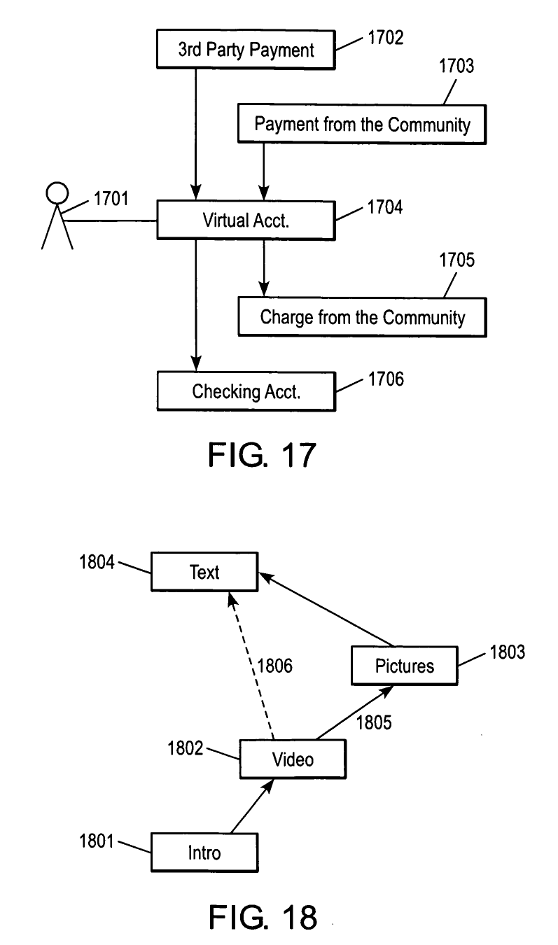

FIG. 17 illustrates an example of a virtual economy system. In FIG. 17, a subscriber, a content producer or an owner of a community can be an owner 1701 of a virtual account 1704. The virtual account 1704 may be funded by a third-party payment service 1702. The balance of the virtual account 1704 may be transferred to a checking account 1706. In addition, the payments 1703 and charges 1705 from the community may be credited and debited to the virtual account 1704.

### Community Certification System

The community certification system evaluates the quality of a community. The quality of the community can be determined by various factors, e.g., content quality by user's review rating, amount of data in the data store of the community, level of enrollment, or education or experience level of the content producers. There may be a background check of the owner and the content producers of a community.

The factors used to determine the quality of a community may be tailor to each community.

A community certificate can be issued based on the evaluation of the quality of a community.

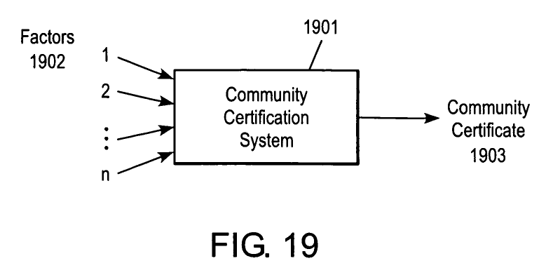

FIG. 19 illustrates an example of a community certification system. Various factors 1901 1−n, such as, content quality by user's review rating, amount of data in the data store of the community, can be based upon to determine the quality of a community. The community certification system can issue a certification 1903 based on the quality of the community determined.

### Learning Flow System

The learning flow system organizes the contents of a community into a flow, e.g., for a beginner of a Roman Empire. The beginning of the flow may be an introduction document of a Roman Empire. The next item in the flow may be a video of a Roman Empire. The flow helps the subscribe to acquire the knowledge in an optimal way.

The learning flow for different level of subscribers can be customized to the level of the knowledge.

FIG. 18 illustrates an example of a learning flow system. For a given community, the contents include an introduction 1801, a video 1802, pictures 1803, and text documents 1804 on the topic. A learning flow for a beginner level 1805, specifies the order of the introduction 1801, the video 1802, the pictures 1803, and the text documents 1804 for the subscriber to study. A second learning flow 1806 for a subscriber of a more advance level specifies the order of the video 1802, and the text documents 1804 for the subscriber to study.

### Third-Party Web Services

The system is capable of adding multiple third-party web services, e.g., JAJAH, which provides web-activated telephony that allows user to make calls.

The content of the calls may be used to determine the interests of the user, and advertisement of learning communities of the user's interested may be specifically provided to the user.

### People Finder and Progress Indicator

The people finder function within the parent service system can allow subscribers to find other community members or subscribers to attend.

This system automatically recommends subscribers on their level within the community who match certain criteria. First, they can search on the community attendance index to determine which people have been actively participating in the chosen community. Once this data is brought back, the system can automatically sort based on the user's profile preferences. A first criterion can be on location. The system shows the users, who are attending the community and are active, based on location. A second criteria can be based on profile interests. The user sends out a notification to a chosen user to ask them if they would be interested in working through the community material together. The group of users is able to work through the community material together and check each other's status by looking at the people status indicator.

In addition, users on higher levels can use this system to look for lower level users to mentor. Since mentoring (answering questions, responding to discussion postings, hosting a chat or review session) is part of getting to the next level in a community, higher level users need to look for lower level users to mentor, and this system can be used to do that. Once subscribers team with each other, and agree to work through a community together, they can be able to check the status of the subscribers they are working with through the people status indicator.

The people status indicator can use the learning community attendance system to determine how far a subscriber has progressed through the current level in the community. Subscribers can see which items have been submitted by the other subscribers on their team, the amount of activity for each user, and the amount of logins to the site and other information. The status indicator can show a progress indicator that goes from Start to Finish, and show the status for each of the users on the team. Subscribes can send messages to each other, or send messages of praise to members of their team. In addition, higher level users who are mentoring lower level subscribers can check the status of subscribers they are mentoring through this tool.

### Community Recommendation System

This system should make recommendations based on past choice views and communities attended. This means, for instance, if a person joins or subscribes a community on Roman History, the system would automatically recommend a community on Greek History.

An optional feature is a Content Sales System, which is associated with the subscriber billing system. The Content Sales System allows a subscriber to set a price for a files containing images, documents, audio content or video content, or folders, i.e., collection of files, containing a mix of content, which the selling subscriber can offer for sale to other subscribers. The selling subscriber can limit number of times the document can be shared (i.e. the number of shares) with other subscribers by the buying subscriber as well as the number of downloads per sale.

### System Implementation

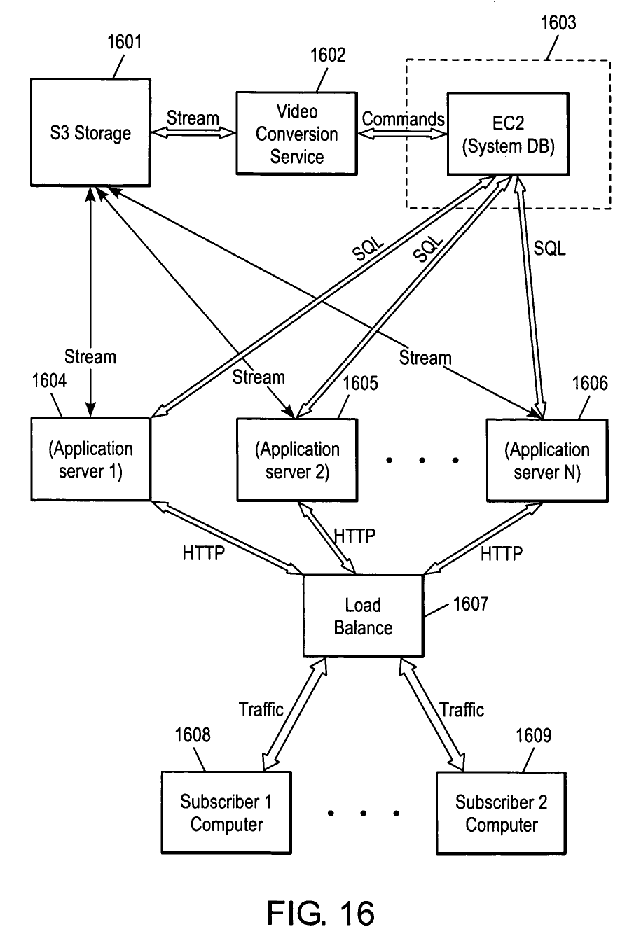

The above described method and system can be implemented in an exemplary computer system as shown in FIG. 16. The system can be implemented on any type of server-based system that is accessible by a plurality of user computers for distribution of content. The content can be stored in any of a number of well-known data storage systems that allow for distribution of the content to a plurality of users.

In the exemplary embodiment, the server applications are hosted as separate instances run inside the Amazon Elastic Computing Cloud (EC2) 1603. As the server load increases, application server instances are added at EC2 1603. Initial contact to the EC is through Application servers 1−N, such as block 1604, 1605 and 1606, which can be implemented through servlets, such as an Apache Tomcat. The traffic from subscriber computers 1−N can be managed by a traffic load balancer 1607, which is available through Apache. An optional feature shown in FIG. 16 is the video conversion service 1602 that converts data stored in database 1601 or other date storage means, such as Amazon Simple Storage Service.

### CONCLUSION

While the disclosure has been shown and described with particular reference to various embodiments thereof, it will be understood that variations and modifications in form and details may be made therein without departing from the spirit and scope of the disclosure as defined in the appended claims.

What is claimed is:

1. A method for distributing knowledge through a learning community, comprising:
creating a plurality of learning communities;
for each of the plurality of learning communities, allowing creating a knowledge base by one or more content producers;
for each of the plurality of learning communities, allowing submitting content to the learning community by at least one of the one or more content consumers and content producers; and
for each of the plurality of learning communities, sharing contents with the one or more content consumers and content producers in a plurality of ways;
wherein the plurality of learning communities are listed in a directory; a category in the directory being able to be drilled into for multiple levels; each of the multiple levels of categories in the directory associated with one or more of the plurality of learning communities.

2. The method of claim 1, wherein each of the plurality of learning communities includes one or more of images, discussion boards, chat rooms, blogs, live and static video, audio files, reading materials, assignments, projects and lectures.

3. The method of claim 1, further comprising assigning the one or more content consumers and content producers different statuses, which correspond to different abilities within the plurality of learning communities.

4. The method of claim 3, wherein the different abilities within the plurality of learning communities are different levels of access.

5. The method of claim 1, further comprising tracking actions taken within the plurality of learning communities with an attendance system and rewarding points in a point system based on the tracking.

6. The method of claim 5, wherein when a content producer or a content consumer accumulates sufficient points in the point system, the content producer or the content consumer is given the status of the next higher level.

7. The method of claim 5, wherein the actions comprise all participating activities of the content consumers, and all managing and participating activities of the content producers.

8. The method of claim 1, further comprising creating respective community management teams for the plurality of learning communities; the community management teams reviewing content submitted; approving or denying content submitted, adding or removing contents for the plurality of learning communities.

9. The method of claim 8, wherein each of the community management teams comprises one or more management team members, each of the management team member has different reviewing authorities.

10. The method of claim 9, wherein the different reviewing authorities comprise reviewing format of the content submitted by a content consumer and accrediting a first point value in the point system to the content consumer based on the format of the content submitted, reviewing spelling and grammar of the content submitted by a content consumer and accrediting a second point value in the point system to the content consumer based on the spelling and grammar of the content submitted; and deciding whether the submitted content is denied or approved and accrediting a third point value in the point system to the content consumer based on the decision.

11. The method of claim 8, wherein the community management teams receive points in a point system for managing activities.

12. The method of claim 1, further comprising adding dates of content items in a community to a content consumer's calendar when the content consumer signs up for the community.

13. The method of claim 1, wherein each of the plurality of learning communities is assigned a setting, possible settings are Invite Only, Request to Join, Password Protected, and Freely Accessible.

14. The method of claim 1, wherein a learning community is assigned one or more access levels, each content in the learning community is associated with one of the one or more access levels, a content consumer joins the learning community at the lowest access level, and moves up the access levels according to points accumulated in the learning community, and the content consumer can only access a content in the learning community associated with an access levels not greater than access level of the content consumer.

15. The method of claim 1, further comprising allowing a content subscriber to post a question on an open question list.

16. The method of claim 15, further comprising posting an answer to the question if the answer is approved by the content subscriber who posted the question.

17. The method of claim 1, further comprising allowing a content subscriber to post an item that is wanted in a wants and wishes list.

18. The method of claim 17, further comprising:
tagging a new community with an entry of the wants and wishes list if the new community satisfies description of the entry, and
notifying a user who posted the entry.

19. The method of claim 18, further comprising removing the entry from the wants and wishes list if the new community satisfies description of the entry.

20. The method of claim 1, further comprising:
providing respective virtual accounts for the one or more content consumers and content producers; and
transferring a monetary value from or into the virtual accounts.

21. The method of claim 20, further comprising allowing the one or more content consumers and content producers to borrow a loan by allowing values of their respective virtual accounts to be negative.

22. The method of claim 20, wherein the virtual accounts are funded through a third-party payment service.

23. The method of claim 20, further comprising paying an interest on balances maintained in the virtual accounts.

24. The method of claim 20, further comprising tracking tax identifications of the one or more content consumers and content producers; and associating the tax identifications with transactions of the transferring a monetary value from or into the virtual accounts.

25. The method of claim 1, further comprising providing respective ratings of the plurality of learning communities based on one or more factors of the respective content producers, content consumers and contents.

26. The method of claim 1, further comprising a learning flow which specifies an order of contents in a community to be studies for a community consumer.

27. The method of claim 26, wherein the learning flow is customized based on a level of a community consumer.

28. A system for distributing knowledge through a learning community, comprising:
means for creating a plurality of learning communities;
means for allowing creating a knowledge base by one or more content producers;
means for allowing submitting content to the learning community by at least one of the one or more content consumers and content producers; and
means for sharing contents with the one or more content consumers and content producers in a plurality of ways;
wherein the plurality of learning communities are listed in a directory; a category in the directory being able to be drilled into for multiple levels; each of the multiple levels of categories in the directory associated with one or more of the plurality of learning communities.
